(19) United States
(12) Patent Application Publication
(10) Pub. No.: US 2025/0216823 A1
(43) Pub. Date: Jul. 3, 2025

(54) CONTROL DEVICE AND CONTROL METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Yutaka YAMADA, Fuchu Tokyo (JP); Koji SUZUKI, Fuchu Tokyo (JP)

(21) Appl. No.: 18/824,765

(22) Filed: Sep. 4, 2024

(30) Foreign Application Priority Data
Dec. 28, 2023 (JP) 2023-222286

(51) Int. Cl. G05B 13/04; G05B 13/02

(52) U.S. Cl. CPC G05B 13/048; G05B 13/0265

(57) ABSTRACT

A control device includes a controller, a predictor, and a corrector. The controller generates a control value on the basis of a command value and an output value output from a control target. The predictor predicts the output value on the basis of an input value input to the control target and a predictive model of the control target and generates a prediction value indicating a result of predicting the output value. The corrector corrects the control value on the basis of the command value, the output value, and the prediction value. The input value input to the control target is the control value corrected by the corrector.

### CROSS-REFERENCE TO RELATED APPLICATION

This application is based upon and claims the benefit of priority from Japanese Patent Application No. 2023-222286, filed Dec. 28, 2023; the entire contents of which are incorporated herein by reference.

### FIELD

Embodiments described herein relate generally to a control device and a control method.

### BACKGROUND

Model predictive control (MPC) is generally known as a feedback control method. In MPC, a process of calculating an input value to be input to a control target at each time included in a prediction segment by predicting the behavior of the control target in the prediction segment from a current time to a future time based on a command value, an output value of the control target, and a predictive model of the control target and further searching for an input value for minimizing an area of an error between the command value and the output value in the prediction segment is performed. In this MPC, a calculation amount in the control device significantly increases because it is necessary to perform a prediction process and a process of solving an optimization problem.

### BRIEF DESCRIPTION OF THE DRAWINGS

FIG. 1 is a block diagram showing a configuration of a control device of a first embodiment.

FIG. 2 is a flowchart showing an operation of the control device of the first embodiment.

FIG. 3 is a block diagram showing a first modified example of the control device of the first embodiment.

FIG. 4 is a block diagram showing a second modified example of the control device of the first embodiment.

FIG. 5 is a block diagram showing an application example of the control device of the first embodiment.

FIG. 6 is a block diagram showing a modified example of the application example shown in FIG. 5.

FIG. 7 is a block diagram showing a configuration of a control device of a second embodiment.

FIG. 8 is a block diagram showing an application example of the control device of the second embodiment.

### DETAILED DESCRIPTION

A control device according to embodiments includes a controller, a predictor, and a corrector. The controller generates a control value based on a command value and an output value output from a control target. The predictor predicts the output value based on an input value input to the control target and a predictive model of the control target and generates a prediction value indicating a result of predicting the output value. The corrector corrects the control value based on the command value, the output value, and the prediction value. The input value input to the control target is the control value corrected by the corrector.

Hereinafter, control devices of embodiments will be described with reference to the drawings.

### First Embodiment

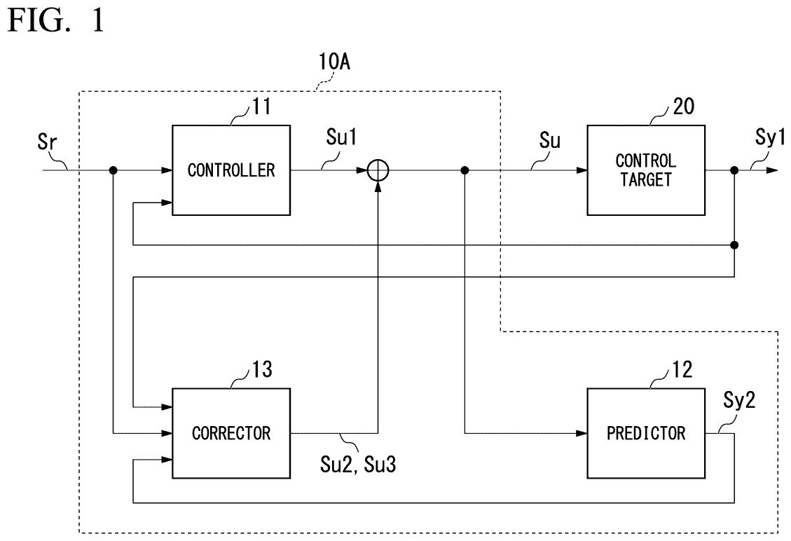

FIG. 1 is a block diagram schematically showing a configuration of a control device 10A of a first embodiment. The control device 10A is a device for performing a feedback control process for a control target 20 in a predetermined control cycle. As will be described below, the control target 20 includes, for example, a direct current (DC) motor or the like. However, hereinafter, a basic configuration of the control device 10A will be described first without specifying a type of the control target 20.

The control target 20 outputs a control output value Sy1 in response to a control input value Su input to the control target 20. The control input value Su is a manipulation quantity output from the control device 10A to the control target 20. The control input value Su is an example of an input value input to the control target 20. A control output value Sy1 is an example of an output value output from the control target 20.

The command value Sr and the control output value Sy1 are input to the control device 10A. For example, the command value Sr is input from a higher-order control device (not shown) to the control device 10A. The control device 10A controls the control input value Su so that the control output value Sy1 is close to the command value Sr. The control device 10A includes a controller 11, a predictor 12, and a corrector 13.

The command value Sr and the control output value Sy1 are input to the controller 11. The controller 11 generates a control value Su1 for making the control output value Sy1 close to the command value Sr based on the command value Sr and the control output value Sy1. More specifically, the controller 11 generates a control value Su1 in a t^{th} control cycle based on the command value Sr and the control output value Sy1 obtained at a start timing of the t^{th} control cycle. t denotes the temporal order of the control cycle and is an integer of 1 or more. Hereinafter, for convenience of description, “(t)” may be added to the sign of each value corresponding to the t^{th} control cycle.

For example, the controller 11 may generate a control value Su1 by performing proportional-integral-derivative (PID) control based on the command value Sr and the control output value Sy1. Alternatively, the controller 11 may generate the control value Su1 based on a control model obtained by machine learning such as deep learning. A method of generating the control value Su1 in the controller 11 is not particularly limited.

The control input value Su is input to the predictor 12. The predictor 12 predicts the control output value Sy1 based on the control input value Su and the predictive model of the control target 20 and generates a prediction value Sy2 indicating a result of predicting the control output value Sy1. The prediction value Sy2 is the control output value Sy1 predicted to be output from the control target 20 in response to the control input value Su. More specifically, the predictor 12 predicts the control output value Sy1 to be output from the control target 20 in a subsequent cycle in the future based on the control input value Su obtained at the start timing of the t^{th} control cycle.

As described above, the predictor 12 acquires the control input value Su when the start timing of the t^{th} control cycle has been reached. However, because the control input value Su in the t^{th} control cycle has not yet been determined at this time, the control input value Su acquired by the predictor 12 becomes a control input value Su(t−1) input to the control target 20 in a previous cycle, i.e., a (t−1)^{th} control cycle. That is, when the start timing of the t^{th} control cycle is reached, the predictor 12 predicts a control output value Sy1(t) output from the control target 20 in a subsequent cycle, i.e., a t^{th} control cycle, based on the control input value Su(t−1) of the (t−1)th control cycle.

Examples of the predictive model include a step response model, an impulse response model, a transfer function model, a machine learning model, an equation of state, and the like. For example, when the equation of state is used as a predictive model of a DC motor, the equation of state of the DC motor is represented by the following Eq. (1). In the following Eq. (1), i(t) denotes an electric current flowing through the DC motor. ω(t) denotes an angular velocity of the DC motor. R denotes a resistance value of the DC motor. L denotes an inductance value of the DC motor. J denotes the moment of inertia of the DC motor. K1 denotes a back electromotive constant of the DC motor. K2 denotes a torque constant of the DC motor. v(t) denotes a voltage applied to the DC motor, i.e., an input value of the DC motor. Tⱼ(t) denotes an external torque applied to the DC motor as a disturbance. y(t) denotes an output value of the DC motor.

$$\begin{matrix}\frac{d}{dt} [ \begin{matrix}i ( t ) \\ ω ( t )\end{matrix} ] = [ \begin{matrix}- R / L & - K 1 / L \\ K 2 / J & - R / J\end{matrix} ] [ \begin{matrix}i ( t ) \\ ω ( t )\end{matrix} ] + [ \begin{matrix}1 / L \\ 0\end{matrix} ] v ( t ) + [ \begin{matrix}0 \\ - 1 / J\end{matrix} ] {T}_{j} ( t ) \\ y ( t ) = [ \begin{matrix}i ( t ) \\ ω ( t )\end{matrix} ]\end{matrix} \} \qquad ( 1 )$$

For example, when a machine learning model is used as a predictive model, the machine learning model is represented by the following Eq. (2). In the following Eq. (2), y(t) denotes a control output value Sy1 obtained in the t^{th} control cycle. u(t) denotes the control input value Su obtained in the t^{th} control cycle. y(t+1) denotes a control output value Sy1 predicted to be output from the control target 20 in the (t+1)^{th} control cycle.

$$y ( t + 1 ) = f ( y ( t ) , u ( t ) ) \qquad ( 2 )$$

For example, it is possible to obtain a machine learning model as represented by the above Eq. (2) by applying learning data including the control input value Su and the control output value Sy1 output from the control target 20 in response to the control input value Su to artificial intelligence (AI) and causing the AI to learn the behavior of the control target 20. In addition, when the machine learning model as represented by the above Eq. (2) is used as a predictive model, the control output value Sy1 may also be input to the predictor 12 in addition to the control input value Su.

The command value Sr, the control output value Sy1, and the prediction value Sy2 are input to the corrector 13. The corrector 13 corrects the control value Su1 on based on the command value Sr, the control output value Sy1, and the prediction value Sy2. For example, when the control output value Sy1 is farther from the command value Sr than the prediction value Sy2, the corrector 13 corrects the control value Su1 so that the control output value Sy1 is close to the command value Sr. Moreover, when the control output value Sy1 is closer to the command value Sr than the prediction value Sy2, the corrector 13 corrects the control value Su1 so that the control output value Sy1 is farther from the command value Sr.

For example, a first correction method of adding the correction value to the control value Su1 generated by the controller 11 and a second correction method of changing a control parameter to be used by the controller 11 to generate the control value Su1 are mentioned as methods of correcting the control value Su1. In other words, “correcting the control value Su1” includes directly correcting the control value Su1 by adding the correction value and indirectly correcting the control value Su1 by changing the control parameter to be used by the controller 11. In the first embodiment, a configuration in which the corrector 13 corrects the control value Su1 by the first correction method will be described. A configuration in which the corrector 13 corrects the control value Su1 by the second correction method will be described in a second embodiment.

In the first embodiment, the corrector 13 generates a first correction value Su2 having the same positive or negative sign as the control value Su1 and adds the first correction value Su2 to the control value Su1 when the control output value Sy1 is farther from the command value Sr than the prediction value Sy2. Moreover, the corrector 13 generates a second correction value Su3 having a positive or negative sign different from that of the control value Su1 and adds the second correction value Su3 to the control value Su1 when the control output value Sy1 is closer to the command value Sr than the prediction value Sy2.

For example, when the command value Sr, the control output value Sy1, and the prediction value Sy2 satisfy the following Conditional Inequality (3), the corrector 13 determines that the control output value Sy1 is farther from the command value Sr than the prediction value Sy2.

$$\vert Sy 2 - Sr \vert < \vert Sy 1 - Sr \vert \qquad ( 3 )$$

Moreover, for example, when the command value Sr, the control output value Sy1, and the prediction value Sy2 satisfy the following Conditional Inequality (4), the corrector 13 determines that the control output value Sy1 is closer to the command value Sr than the prediction value Sy2.

$$\vert Sy 2 - Sr \vert \geq \vert Sy 1 - Sr \vert \qquad ( 4 )$$

In addition, the corrector 13 acquires the command value Sr(t), the control output value Sy1(t), and the prediction value Sy2(t) when the start timing of the t^{th} control cycle has been reached. However, because the control input value Su in the t^{th} control cycle has not yet been determined at this point, the control output value Sy1(t) and the prediction value Sy2(t) acquired by the corrector 13 are values corresponding to the control input value Su(t−1) input to the control target 20 in a previous cycle, i.e., a (t−1)th control cycle. Therefore, the control output value Sy1(t) and the prediction value Sy2(t) acquired by the corrector 13 include a time delay component corresponding to one cycle with respect to the command value Sr(t).

To reduce an influence of the delay component as described above, it is preferable for the corrector 13 to save the command value Sr(t−1) obtained in the previous control cycle, i.e., the (t−1)th control cycle, and make the above-described determination based on the command value Sr(t−1), the control output value Sy1(t), and the prediction value Sy2(t) in the t^{th} control cycle. Thereby, because the influence of the delay component is reduced, the accuracy of the above-described determination can be improved. In addition, when a possibility that the command value Sr will significantly change between adjacent control cycles is low, the corrector 13 may perform the above-described determination based on the command value Sr(t), the control output value Sy1(t), and the prediction value Sy2(t) obtained at the start timing of the t^{th} control cycle.

For example, when the control output value Sy1 is farther from the command value Sr than the prediction value Sy2, the corrector 13 generates the first correction value Su2 according to the following Eq. (5). In the following Eq. (5), a is a constant.

$$Su 2 = \{ \begin{matrix}- α D , ( Sr - Sy 1 ) < 0 ( Su 1 < 0 ) \\ α D , ( Sr - Sy 1 ) \geq 0 ( Su 1 \geq 0 )\end{matrix} \qquad ( 5 )$$

When the control output value Sy1 is farther from the command value Sr than the prediction value Sy2, a difference D in the above Eq. (5) is represented by the following Eq. (6).

$$D = \vert Sr - Sy 1 \vert - \vert Sr - S γ 2 \vert \geq 0 \qquad ( 6 )$$

As described above, if the control output value Sy1 is farther from the command value Sr than the prediction value Sy2, the first correction value Su2 becomes “−αD” when the control value Su1 is a negative value and the first correction value Su2 becomes “αD” when the control value Su1 is a positive value. When the control output value Sy1 is farther from the command value Sr than the prediction value Sy2, the corrector 13 adds the first correction value Su2 as described above to the control value Su1, such that the control value Su1 is strengthened.

For example, when the control output value Sy1 is closer to the command value Sr than the prediction value Sy2, the corrector 13 generates a second correction value Su3 according to the following Eq. (7). In the following Eq. (7), a is a constant.

$$Su 3 = \{ \begin{matrix}- α D , ( Sr - Sy 1 ) < 0 ( Su 1 \geq 0 ) \\ α D , ( Sr - Sy 1 ) \geq 0 ( Su 1 < 0 )\end{matrix} \qquad ( 7 )$$

When the control output value Sy1 is closer to the command value Sr than the prediction value Sy2, a difference D in Eq. (7) is represented by the following Eq. (8).

$$D = \vert Sr - Sy 1 \vert - \vert Sr - S γ 2 \vert < 0 \qquad ( 8 )$$

As described above, if the control output value Sy1 is closer to the command value Sr than the prediction value Sy2, the second correction value Su3 becomes “−αD” when the control value Su1 is a positive value and the second correction value Su3 becomes “αD” when the control value Su1 is a negative value. When the control output value Sy1 is closer to the command value Sr than the prediction value Sy2, the corrector 13 adds the second correction value Su3 as described above to the control value Su1, such that the control value Su1 is weakened.

As the control input value Su in the t^{th} control cycle, a value obtained by adding the first correction value Su2 or the second correction value Su3 to the control value Su1 in the corrector 13 is input to the control target 20. Thus, the control input value Su of the control target 20 is the control value Su1 corrected by the corrector 13.

When the control output value Sy1 is farther from the command value Sr than the prediction value Sy2, the control value Su1 strengthened by the first correction value Su2 is input to the control target 20 as the control input value Su(t) in the t^{th} control cycle. As a result, in the (t+1)^{th} control cycle, a control output value Sy1(t+1) close to the command value Sr(t) is output from the control target 20 as a response to the control input value Su(t).

On the other hand, when the control output value Sy1 is closer to the command value Sr than the prediction value Sy2, the control value Su1 weakened by the second correction value Su3 is input to the control target 20 as the control input value Su(t) in the t^{th} control cycle. As a result, in the (t+1)th control cycle, a control output value Sy1(t+1) far from the command value Sr(t) is output from the control target 20 as a response to the control input value Su(t).

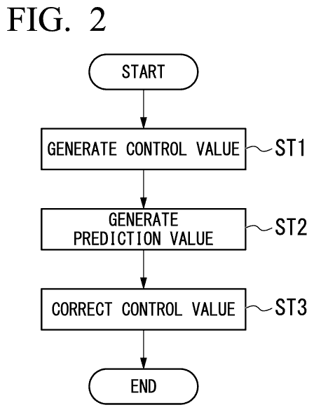

FIG. 2 is a flowchart showing an operation of the control device 10A configured as described above. A control method of the present embodiment is implemented when the control device 10A operates as follows. The control device 10A repeatedly executes the operation shown in the flowchart of FIG. 2 in a predetermined control cycle.

As shown in FIG. 2, when the start timing of the t^{th} control cycle is reached, the controller 11 of the control device 10A first generates the control value Su1 based on the command value Sr and the control output value Sy1 obtained at the start timing of the t^{th} control cycle (step ST1). Because a method in which the controller 11 generates the control value Su1 has been described above, redundant description thereof will be omitted here.

Subsequently, the predictor 12 of the control device 10A predicts the control output value Sy1 based on the control input value Su obtained at the start timing of the t^{th} control cycle and the predictive model of the control target 20 and generates the prediction value Sy2 indicating a result of predicting the control output value Sy1 (step ST2). Because a method in which the predictor 12 generates the prediction value Sy2 has been described above, redundant description thereof will be omitted here.

Subsequently, the corrector 13 of the control device 10A corrects the control value Su1 based on the command value Sr, the control output value Sy1, and the prediction value Sy2 (step ST3). For example, when the control output value Sy1 is farther from the command value Sr than the prediction value Sy2, the corrector 13 corrects the control value Su1 so that the control output value Sy1 is close to the command value Sr. Moreover, when the control output value Sy1 is closer to the command value Sr than the prediction value Sy2, the corrector 13 corrects the control value Su1 so that the control output value Sy1 is far from the command value Sr. Because a method in which the corrector 13 corrects the control value Su1 has been described above, redundant description thereof will be omitted here.

When the control device 10A performs feedback control for the control target 20 at the predetermined control cycle as described above, a control process is performed so that the control output value Sy1 of the control target 20 becomes a value close to the command value Sr.

According to the present embodiment, the control device 10A includes the controller 11 configured to generate the control value Su1 based on the command value Sr and the control output value Sy1 output from the control target 20, the predictor 12 configured to predict the control output value Sy1 based on the control input value Su input to the control target 20 and a predictive model of the control target 20 and generate the prediction value Sy2 indicating a result of predicting the control output value Sy1, and the corrector 13 configured to correct the control value Su1 based on the command value Sr, the control output value Sy1, and the prediction value Sy2, wherein the control input value Su input to the control target 20 is the control value Su1 corrected by the corrector 13. According to such an embodiment, it is only necessary for the predictor 12 to predict the control output value Sy1 output from the control target 20 in response to the control input value Su of the control target 20. For example, as described above, it is only necessary for the predictor 12 to predict the control output value Sy1 to be output from the control target 20 in a subsequent cycle in the future based on the control input value Su obtained at the start timing of the t^{th} control cycle. Therefore, according to the present embodiment, a calculation amount during the prediction process can be reduced compared with MPC for predicting the behavior of a control target in a prediction segment from a current time to a future time. Moreover, according to the present embodiment, because the control value Su1 corrected based on the command value Sr, the control output value Sy1, and the prediction value Sy2 is given to the control target 20 as the control input value Su, it is not necessary to perform a process of solving the optimization problems so that a control input value for minimizing an area of an error between the command value and the control output value in the prediction segment is searched for like the MPC. As described above, according to the present embodiment, the control device 10A capable of reducing the amount of calculation compared to the MPC can be provided.

In the control device 10A of the present embodiment, the corrector 13 corrects the control value Su1 so that the control output value Sy1 is close to the command value Sr when the control output value Sy1 is farther from the command value Sr than the prediction value Sy2. Moreover, when the control output value Sy1 is closer to the command value Sr than the prediction value Sy2, the corrector 13 corrects the control value Su1 so that the control output value Sy1 is farther from the command value Sr. According to such an embodiment, the control target 20 is controlled so that the control output value Sy1 is close to the command value Sr when the control output value Sy1 is farther from the command value Sr than the prediction value Sy2. In contrast, the control target 20 is controlled so that the control output value Sy1 is farther from the command value Sr when the control output value Sy1 is closer to the command value Sr than the prediction value Sy2. Thereby, it is possible to implement feedback control for maintaining the control output value Sy1 at a value close to the command value Sr while suppressing the occurrence of overshoot.

In the control device 10A of the present embodiment, when the control output value Sy1 is farther from the command value Sr than the prediction value Sy2, the corrector 13 generates a first correction value Su2 having the same positive or negative sign as the control value Su1 and adds the first correction value Su2 to the control value Su1. Moreover, when the control output value Sy1 is closer to the command value Sr than the prediction value Sy2, the corrector 13 generates a second correction value Su3 having a positive or negative sign different from that of the control value Su1 and adds the second correction value Su3 to the control value Su1. According to the present embodiment, because it is only necessary for the corrector 13 to add the first correction value Su2 having the same positive or negative sign as the control value Su1 to the control value Su1 when the control output value Sy1 is farther from the command value Sr than the prediction value Sy2 and to add the second correction value Su3 having a positive or negative sign different from that of the control value Su1 to the control value Su1 when the control output value Sy1 is closer to the command value Sr than the prediction value Sy2, it is possible to suppress a calculation amount during a correction process while implementing feedback control for maintaining the control output value Sy1 at a value close to the command value Sr. Thereby, it is possible to suppress an increase in a calculation amount in the control device 10A.

According to the present embodiment, a control method includes generating a control value Su1 based on the command value Sr and the control output value Sy1 output from the control target 20, predicting the control output value Sy1 based on the control input value Su input to the control target 20 and a predictive model of the control target 20, generating the prediction value Sy2 indicating a result of predicting the control output value Sy1, and correcting the control value Su1 based on the command value Sr, the control output value Sy1, and the prediction value Sy2, wherein the control input value Su input to the control target 20 is the control value Su1 corrected based on the command value Sr, the control output value Sy1, and the prediction value Sy2. According to this present embodiment, it is only necessary to predict the control output value Sy1 output from the control target 20 in response to the control input value Su of the control target 20. For example, as described above, it is only necessary to predict the control output value Sy1 to be output from the control target 20 in a subsequent cycle in the future on the basis of the control input value Su obtained at the start timing of the t^{th} control cycle. Therefore, according to the present embodiment, the calculation amount during the prediction process can be reduced as compared with the MPC for predicting the behavior of the control target in the prediction segment from the current time to the future time. Moreover, according to the present embodiment, because the control value Su1 corrected on the basis of the command value Sr, the control output value Sy1, and the prediction value Sy2 is given to the control target 20 as the control input value Su, it is not necessary to perform a process of solving the optimization problems so that a control input value for minimizing an area of an error between the command value and the control output value in the prediction segment is searched for like the MPC. As described above, according to the present embodiment, it is possible to provide a control method by which the calculation amount can be reduced compared to the MPC.

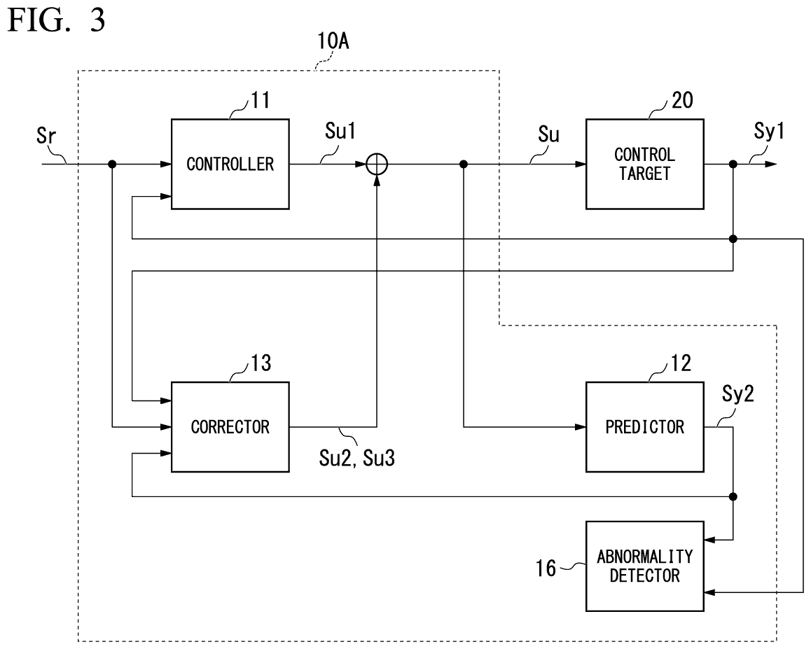

FIG. 3 is a block diagram showing a first modified example of the control device 10A. As shown in FIG. 3, the control device 10A may further include an abnormality detector 16. The control output value Sy1 and the prediction value Sy2 are input to the abnormality detector 16. The abnormality detector 16 detects an abnormality based on the deviation between the control output value Sy1 and the prediction value Sy2.

For example, when a first condition in which the control value Su1 is continuously corrected in the same direction during a period including a plurality of control cycles is satisfied, the abnormality detector 16 determines whether an absolute value of a deviation between the control output value Sy1 and the prediction value Sy2 is greater than or equal to a predetermined value. The abnormality detector 16 determines that an abnormality has occurred when the absolute value of the deviation between the control output value Sy1 and the prediction value Sy2 is greater than or equal to the predetermined value, i.e., when the control output value Sy1 is not close to the prediction value Sy2.

Alternatively, for example, when a second condition in which a correction value generated in the t^{th} control cycle is greater than or equal to a threshold value is satisfied, the abnormality detector 16 may determine whether the absolute value of the deviation between the control output value Sy1 and the prediction value Sy2 is greater than or equal to the predetermined value. The correction value generated in the t^{th} control cycle is the first correction value Su2 or the second correction value Su3 generated by the corrector 13 in the t^{th} control cycle.

As described above, when the first condition or the second condition is satisfied, if the control output value Sy1 is not close to the prediction value Sy2, there is a possibility that a large disturbance will be added to the control target 20 or the control device 10A will fail. Therefore, the abnormality detector 16 as described above is provided in the control device 10A, it is possible to detect an abnormality caused by the disturbance or the failure of the control device 10A.

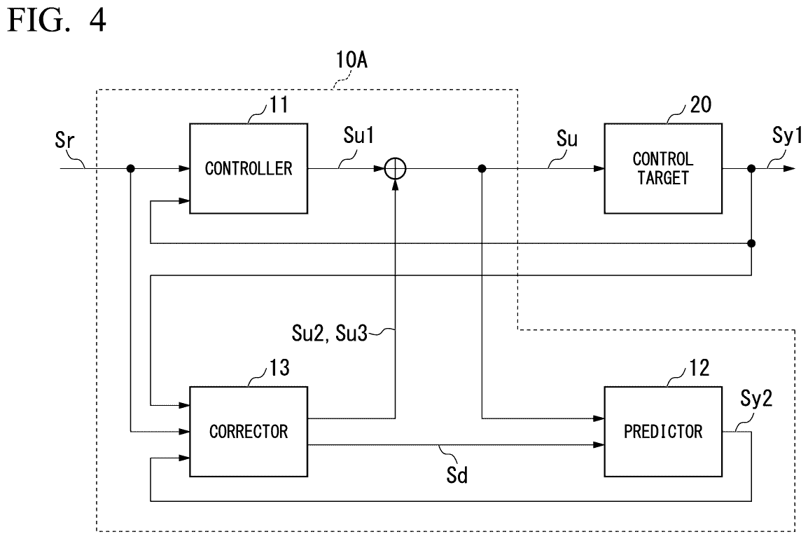

FIG. 4 is a block diagram showing a second modified example of the control device 10A. The corrector 13 in the second modified example has a function of correcting a disturbance parameter to be included in a predictive model for use in the predictor 12. The disturbance parameter is a parameter related to the disturbance among the parameters included in the predictive model. The corrector 13 corrects the disturbance parameter to be included in the predictive model based on the command value Sr, the control output value Sy1, and the prediction value Sy2. The corrector 13 outputs a disturbance correction value Sd for correcting the disturbance parameter to the predictor 12.

For example, when the command value Sr, the control output value Sy1, and the prediction value Sy2 satisfy the condition of Sr>Sy1>Sy2, it is estimated that a disturbance in a positive direction is given to the control target 20 and the disturbance is at work in a direction in which the control output value Sy1 is close to the command value Sr. In this case, the corrector 13 corrects the disturbance parameter in the direction in which the control output value Sy1 is close to the command value Sr.

For example, when the command value Sr, the control output value Sy1, and the prediction value Sy2 satisfy the condition of Sr>Sy2>Sy1, it is estimated that a disturbance in a negative direction is given to the control target 20 and the disturbance is at work in a direction in which the control output value Sy1 is far from the command value Sr. In this case, the corrector 13 corrects the disturbance parameter in the direction in which the control output value Sy1 is far from the command value Sr.

For example, when the command value Sr, the control output value Sy1, and the prediction value Sy2 satisfy the condition of Sy1>Sy2>Sr, it is estimated that a disturbance in a positive direction is given to the control target 20 and the disturbance is at work in a direction in which the control output value Sy1 is far from the command value Sr. In this case, the corrector 13 corrects the disturbance parameter in the direction in which the control output value Sy1 is far from the command value Sr.

For example, when the command value Sr, the control output value Sy1, and the prediction value Sy2 satisfy the condition of Sy2>Sy1>Sr, it is estimated that a disturbance in a negative direction is given to the control target 20 and the disturbance is at work in a direction in which the control output value Sy1 is close to the command value Sr. In this case, the corrector 13 corrects the disturbance parameter in the direction in which the control output value Sy1 is close to the command value Sr.

For example, when the command value Sr, the control output value Sy1, and the prediction value Sy2 satisfy the condition of Sy1>Sr>Sy2, it is estimated that a large disturbance in the positive direction is given to the control target 20 and the disturbance is at work so that the control output value Sy1 overshoots the command value Sr. In this case, the corrector 13 corrects the disturbance parameter so that the control output value Sy1 overshoots the command value Sr.

For example, when the command value Sr, the control output value Sy1, and the prediction value Sy2 satisfy the conditions of Sy2>Sr>Sy1, it is estimated that a large disturbance in the negative direction is given to the control target 20 and the disturbance is at work so that the control output value Sy1 overshoots the command value Sr. In this case, the corrector 13 corrects the disturbance parameter so that the control output value Sy1 overshoots the command value Sr.

As described above, the corrector 13 has a function of correcting disturbance parameters to be included in the predictive model based on the command value Sr, the control output value Sy1, and the prediction value Sy2, such that it is possible to improve the accuracy of prediction of the control output value Sy1 based on the predictive model.

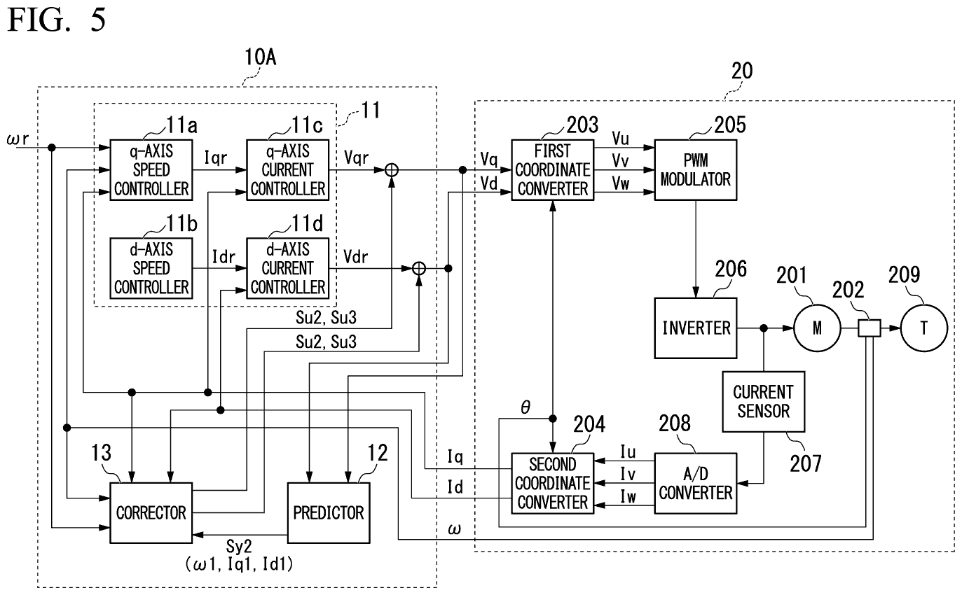

FIG. 5 is a block diagram showing a first application example when the control device 10A of the first embodiment is applied as a control device for controlling the control target 20 including a DC motor 201. As shown in FIG. 5, the control target 20 includes a DC motor 201, a position sensor 202, a first coordinate converter 203, a second coordinate converter 204, and a pulse width modulation (PWM) modulator 205, an inverter 206, a current sensor 207, an analog-to-digital (A/D) converter 208, and a load torque 209. For example, the DC motor 201 is a three-phase brushless DC motor. As a load, the load torque 209 is connected to a rotor shaft of the DC motor 201.

As the control input value Su, the q-axis voltage input value Vq and the d-axis voltage input value Vd are input to the control target 20. That is, the control device 10A outputs the q-axis voltage input value Vq and the d-axis voltage input value Vd to the control target 20.

The position sensor 202 detects a rotor position θ of the DC motor 201 and outputs the rotor position θ to the first coordinate converter 203 and the second coordinate converter 204. The rotor position θ is an electrical angle of the rotor of the DC motor 201. Moreover, the position sensor 202 calculates an angular velocity measurement value ω based on the rotor position θ and outputs the angular velocity measurement value ω to the control device 10A.

The q-axis voltage input value Vq, the d-axis voltage input value Vd, and the rotor position θ are input to the first coordinate converter 203. The first coordinate converter 203 generates a U-phase command value Vu, a V-phase command value Vv, and a W-phase command value Vw by performing coordinate conversion into a three-phase coordinate system from a rotating coordinate system based on the q-axis voltage input value Vq, the d-axis voltage input value Vd, and the rotor position θ. The first coordinate converter 203 outputs the U-phase command value Vu, the V-phase command value Vv, and the W-phase command value Vw to the PWM modulator 205.

The PWM modulator 205 generates a three-phase PWM signal based on the U-phase command value Vu, the V-phase command value Vv, and the W-phase command value Vw and outputs the three-phase PWM signal to the inverter 206. The inverter 206 converts the DC voltage into a three-phase alternating current (AC) voltage based on the three-phase PWM signal and outputs the three-phase AC voltage to the DC motor 201. When the three-phase AC voltage is input to the DC motor 201, the rotor and rotor shaft of the DC motor 201 rotate.

The current sensor 207 detects a three-phase current flowing through the DC motor 201 and outputs an analog value indicating a result of detecting the three-phase current to the A/D converter 208. The A/D converter 208 generates a U-phase current measurement value Iu, a V-phase current measurement value Iv, and a W-phase current measurement value Iw by converting an analog value indicating the result of detecting the three-phase current into a digital value. The A/D converter 208 outputs the U-phase current measurement value Iu, the V-phase current measurement value Iv, and the W-phase current measurement value Iw to the second coordinate converter 204.

The U-phase current measurement value Iu, the V-phase current measurement value Iv, the W-phase current measurement value Iw, and the rotor position θ are input to the second coordinate converter 204. The second coordinate converter 204 generates a q-axis current measurement value Iq and a d-axis current measurement value Id by performing coordinate conversion into a rotating coordinate system from a three-phase coordinate system based on the U-phase current measurement value Iu, the V-phase current measurement value Iv, the W-phase current measurement value Iw, and the rotor position θ. The second coordinate converter 204 outputs the q-axis current measurement value Iq and the d-axis current measurement value Id to the control device 10A.

As described above, the angular velocity measurement value ω, the q-axis current measurement value Iq, and the d-axis current measurement value Id are output from the control target 20 to the control device 10A. That is, the control output value Sy1 of the control target 20 includes the angular velocity measurement value ω, the q-axis current measurement value Iq, and the d-axis current measurement value Id.

The angular velocity command value ωr, the angular velocity measurement value ω, the q-axis current measurement value Iq, and the d-axis current measurement value Id are input to the controller 11 of the control device 10A. The angular velocity command value or is input from the higher-order control device to the control device 10A. The controller 11 includes a q-axis speed controller 11a, a d-axis speed controller 11b, a q-axis current controller 11c, and a d-axis current controller lid.

The angular velocity command value ωr, the angular velocity measurement value ω, and the q-axis current measurement value Iq are input to the q-axis speed controller 11a. The q-axis speed controller 11a generates a q-axis current command value Iqr by performing reinforcement learning (RL) control based on the angular velocity command value ωr, the angular velocity measurement value ω, and the q-axis current measurement value Iq. The q-axis speed controller 11a outputs the q-axis current command value Iqr to the q-axis current controller 11c. The d-axis speed controller 11b generates a d-axis current command value Idr having a zero value and outputs the d-axis current command value Idr to the d-axis current controller 11d.

The q-axis current command value Iqr and the q-axis current measurement value Iq are input to the q-axis current controller 11c. The q-axis current controller 11c generates a q-axis voltage command value Vqr by performing PI control based on the q-axis current command value Iqr and the q-axis current measurement value Iq. The d-axis current command value Idr and the d-axis current measurement value Id are input to the d-axis current controller 11d. The d-axis current controller 11d generates a d-axis voltage command value Vdr by performing PI control based on the d-axis current command value Idr and the d-axis current measurement value Id. As described above, the controller 11 outputs the q-axis voltage command value Vqr and the d-axis voltage command value Vdr as the control value Su1.

The q-axis voltage input value Vq and the d-axis voltage input value Vd are input to the predictor 12 of the control device 10A. The predictor 12 predicts the control output value Sy1 including the angular velocity measurement value ω, the q-axis current measurement value Iq, and the d-axis current measurement value Id based on the q-axis voltage input value Vq, the d-axis voltage input value Vd, and the predictive model of the control target 20 and generates the prediction value Sy2 indicating a result of predicting the control output value Sy1. The prediction value Sy2 includes an angular velocity prediction value ω1, a q-axis current prediction value Iq1, and a d-axis current prediction value Id1. The predictor 12 outputs the prediction value Sy2 to the corrector 13.

The angular velocity command value ωr, the angular velocity measurement value ω, the q-axis current measurement value Iq, the d-axis current measurement value Id, and the prediction value Sy2 are input to the corrector 13 of the control device 10A. The corrector 13 corrects the q-axis voltage command value Vqr and the d-axis voltage command value Vdr based on the angular velocity command value ωr, the angular velocity measurement value ω, the q-axis current measurement value Iq, the d-axis current measurement value Id, and the prediction value Sy2. For example, when the angular velocity measurement value ω is farther from the angular velocity command value or than the angular velocity prediction value co, the corrector 13 corrects the q-axis voltage command value Vqr and the d-axis voltage command value Vdr so that the angular velocity measurement value ω is close to the angular velocity command value or. Moreover, when the angular velocity measurement value ω is closer to the angular velocity command value or than the angular velocity prediction value ω1, the corrector 13 corrects the q-axis voltage command value Vqr and the d-axis voltage command value Vdr so that the angular velocity measurement value ω is far from the angular velocity command value ωr.

More specifically, when the angular velocity measurement value ω is farther from the angular velocity command value or than the angular velocity prediction value co, the corrector 13 generates a first correction value Su2 having the same sign as the q-axis voltage command value Vqr and the d-axis voltage command value Vdr and adds the first correction value Su2 to the q-axis voltage command value Vqr and the d-axis voltage command value Vdr. Moreover, when the angular velocity measurement value ω is closer to the angular velocity command value or than the angular velocity prediction value co, the corrector 13 generates a second correction value Su3 having a sign different from those of the q-axis voltage command value Vqr and the d-axis voltage command value Vdr and adds the second correction value Su3 to the q-axis voltage command value Vqr and the d-axis voltage command value Vdr.

A value obtained by adding the first correction value Su2 or the second correction value Su3 to the q-axis voltage command value Vqr in the corrector 13 is input to the control target 20 as the q-axis voltage input value Vq. Moreover, a value obtained by adding the first correction value Su2 or the second correction value Su3 to the d-axis voltage command value Vdr in the corrector 13 is input to the control target 20 as the d-axis voltage input value Vd.

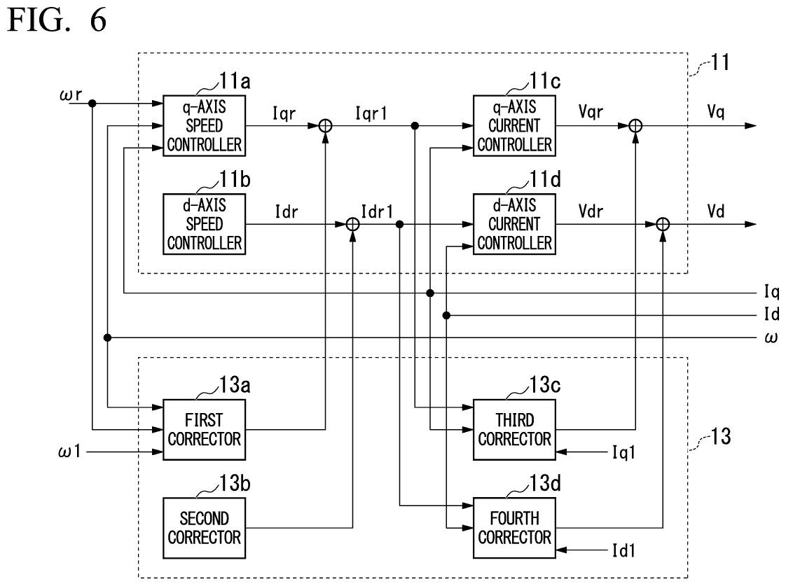

FIG. 6 is a block diagram showing a modified example of the application example shown in FIG. 5. Only the controller 11 and the corrector 13 are shown in FIG. 6 and the other constituent elements are the same as those shown in FIG. 5. As shown in FIG. 6, the corrector 13 may include a first corrector 13a, a second corrector 13b, a third corrector 13c, and a fourth corrector 13d.

The angular velocity command value ωr, the angular velocity measurement value ω, and the angular velocity prediction value ω1 are input to the first corrector 13a. The first corrector 13a corrects the q-axis current command value Iqr output from the q-axis speed controller 11a based on the angular velocity command value ωr, the angular velocity measurement value ω, and the angular velocity prediction value ω1. In the following description, the q-axis current command value Iqr corrected by the first corrector 13a is referred to as a q-axis current correction command value Iqr1. The second corrector 13b corrects the d-axis current command value Idr output from the d-axis speed controller 11b. In the following description, the d-axis current command value Idr corrected by the second corrector 13b is referred to as a d-axis current correction command value Idr1.

The q-axis current correction command value Iqr1, the q-axis current measurement value Iq, and the q-axis current prediction value Iq1 are input to the third corrector 13c. The third corrector 13c corrects the q-axis voltage command value Vqr output from the q-axis current controller 11c based on the q-axis current correction command value Iqr1, the q-axis current measurement value Iq, and the q-axis current prediction value Iq1. The d-axis current correction command value Idr1, the d-axis current measurement value Id, and the d-axis current prediction value Id1 are input to the fourth corrector 13d. The fourth corrector 13d corrects the d-axis voltage command value Vdr output from the d-axis current controller 11d based on the d-axis current correction command value Idr1, the d-axis current measurement value Id, and the d-axis current prediction value Id1.

As described above, it is possible to implement more accurate feedback control by providing the first corrector 13a, the second corrector 13b, the third corrector 13c, and the fourth corrector 13d in correspondence with the q-axis speed controller 11a, the d-axis speed controller 11b, the q-axis current controller 11c, and the d-axis current controller lid.

### Second Embodiment

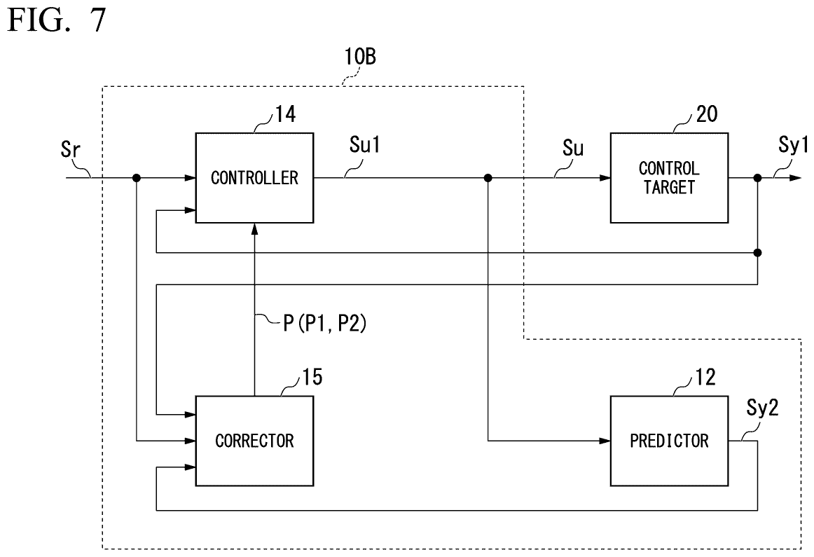

FIG. 7 is a block diagram schematically showing a configuration of a control device 10B of a second embodiment. In the following description, constituent elements identical to those of the first embodiment described above are denoted by the same reference signs and description thereof will be omitted.

As shown in FIG. 7, unlike the control device 10A, the control device 10B includes a controller 14 and a corrector 15 instead of the controller 11 and the corrector 13 described in the first embodiment. Therefore, in particular, the controller 14 and the corrector 15 will be described in detail below. In addition, in the second embodiment, as a control input value Su, a control value Su1 generated by the controller 14 is directly input to the control target 20.

A command value Sr and a control output value Sy1 are input to the controller 14. Based on the command value Sr and the control output value Sy1, the controller 14 generates the control value Su1 for making the control output value Sy1 close to the command value Sr. More specifically, the controller 14 generates the control value Su1 in a t^{th} control cycle on the basis of the command value Sr and the control output value Sy1 obtained at a start timing of the t^{th} control cycle.

The controller 14 generates the control value Su1 based on the command value Sr, the control output value Sy1, and a control parameter P input from the corrector 15. For example, when the controller 14 generates a control value Su1 according to PID control, the control parameter P includes gains Gp, Gi, and Gd corresponding to proportional, integral, and derivative terms for use in the calculation of the PID control. Moreover, for example, when the controller 14 generates the control value Su1 based on a control model obtained by machine learning, the control parameter P includes a weighting factor constituting a control model and the like.

The command value Sr, the control output value Sy1, and a prediction value Sy2 are input to the corrector 15. The corrector 15 corrects the control value Su1 based on the command value Sr, the control output value Sy1, and the prediction value Sy2. For example, when the control output value Sy1 is farther from the command value Sr than the prediction value Sy2, the corrector 15 corrects the control value Su1 so that the control output value Sy1 is close to the command value Sr. Moreover, when the control output value Sy1 is closer to the command value Sr than the prediction value Sy2, the corrector 15 corrects the control value Su1 so that the control output value Sy1 is far from the command value Sr.

The corrector 15 corrects the control value Su1 using the second correction method described above. Specifically, when the control output value Sy1 is farther from the command value Sr than the prediction value Sy2, the corrector 15 outputs a first control parameter P1 for increasing a change quantity of the control value Su1 from a first change quantity to a second change quantity as the control parameter to the controller 14. Moreover, when the control output value Sy1 is closer to the command value Sr than the prediction value Sy2, the corrector 15 outputs a second control parameter P2 for decreasing the change quantity of the control value Su1 from the first change quantity to a third change quantity as the control parameter to the controller 14.

The first change quantity is the change quantity in the control value Su1 generated in a previous control cycle, i.e., a (t−1)^{th} control cycle. The second change quantity is a change quantity greater than the first change quantity. The third change quantity is a change quantity less than the first change quantity.

For example, when the controller 14 generates the control value Su1 according to PID control, the corrector 15 outputs the control parameter P to the controller 14 as follows. That is, when the control output value Sy1 is farther from the command value Sr than the prediction value Sy2, the corrector 15 outputs the first control parameter P1 including gains Gp, Gi, and Gd greater than those used to generate the control value Su1 in the (t−1)^{th} control cycle as the control parameter P to the controller 14. Moreover, when the control output value Sy1 is closer to the command value Sr than the prediction value Sy2, the corrector 15 outputs the second control parameter P2 including gains Gp, Gi, and Gd less than those used to generate the control value Su1 in the (t−1)^{th} control cycle as the control parameter P to the controller 14.

For example, when the controller 14 generates the control value Su1 based on a control model obtained by machine learning, the corrector 15 outputs the control parameter P to the controller 14 as follows. That is, when the control output value Sy1 is farther from the command value Sr than the prediction value Sy2, the corrector 15 outputs a first control parameter P1 including a weighting factor greater than that used to generate the control value Su1 in the (t−1)^{th} control cycle as the control parameter P to the controller 14. Moreover, when the control output value Sy1 is closer to the command value Sr than the prediction value Sy2, the corrector 15 outputs a second control parameter P2 including a weighting factor less than that used to generate the control value Su1 in the (t−1)^{th} control cycle as the control parameter P to the controller 14.

In addition, table data indicating a corresponding relationship between the value of the difference D described in the first embodiment and the control parameter P may be stored in the memory of the control device 10B in advance and the corrector 15 may acquire a control parameter P corresponding to the value of the difference D calculated from the command value Sr, the control output value Sy1 and the prediction value Sy2 as the first control parameter P1 or the second control parameter P2 from the above-described table data.

When the control output value Sy1 is farther from the command value Sr than the prediction value Sy2, the control value Su1 generated to increase the change quantity based on the first control parameter P1 is input to a control target 20 as a control input value Su(t) in the t^{th} control cycle. As a result, in a (t+1)^{th} control cycle, as a response to the control input value Su(t), a control output value Sy1(t+1) close to the command value Sr(t) is output from the control target 20.

On the other hand, when the control output value Sy1 is closer to the command value Sr than the prediction value Sy2, the control value Su1 generated to decrease the change quantity based on the second control parameter P2 is input to the control target 20 as the control input value Su(t) in the t^{th} control cycle. As a result, in the (t+1)^{th} control cycle, as a response to the control input value Su(t), the control output value Sy1(t+1) far from the command value Sr(t) is output from the control target 20.

The control device 10B performs a feedback control process for the control target 20 in a predetermined control cycle as described above and therefore the control output value Sy1 of the control target 20 is controlled so that the control output value Sy1 is a value close to the command value Sr.

In the control device 10B of the present embodiment, the controller 14 generates the control value Su1 based on the command value Sr, the control output value Sy1, and the control parameter P input from the corrector 15. When the control output value Sy1 is farther from the command value Sr than the prediction value Sy2, the corrector 15 outputs the first control parameter P1 for increasing the change quantity of the control value Su1 from the first change quantity to the second change quantity as the control parameter P to the controller 14. Moreover, when the control output value Sy1 is closer to the command value Sr than the prediction value Sy2, the corrector 15 outputs the second control parameter P2 for decreasing the change quantity of the control value Su1 from the first change quantity to the third change quantity as the control parameter P to the controller 14. According to this embodiment, because it is only necessary for the corrector 15 to output the first control parameter P1 to the controller 14 when the control output value Sy1 is farther from the command value Sr than the prediction value Sy2 and output the second control parameter P2 to the controller 14 when the control output value Sy1 is closer to the command value Sr than the prediction value Sy2, it is possible to suppress an increase in a calculation amount during a correction process while implementing feedback control for maintaining the control output value Sy1 at a value close to the command value Sr.

As described in the first modified example of the control device 10A of the first embodiment, the control device 10B of the second embodiment may also further include an abnormality detector 16. Here, redundant description of the abnormality detector 16 will be omitted. Moreover, as described in the second modified example of the control device 10A of the first embodiment, the corrector 15 provided in the control device 10B of the second embodiment may also have a function of correcting a disturbance parameter included in a predictive model used in the predictor 12. Here, redundant description of the function of correcting the disturbance parameter will be omitted.

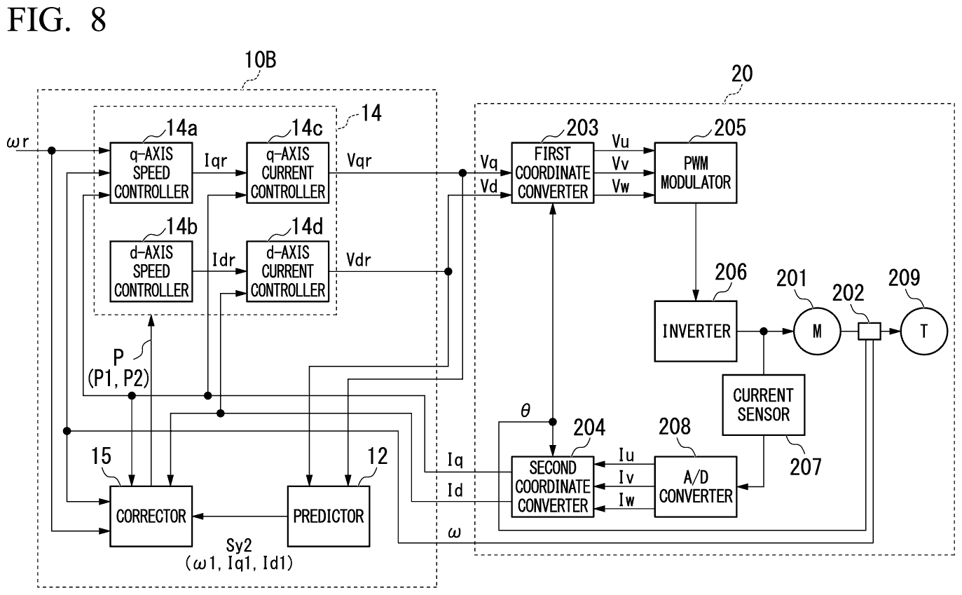

FIG. 8 is a block diagram showing a second application example when the control device 10B of the second embodiment is applied as a control device for controlling the control target 20 including a DC motor 201. In the following description, constituent elements identical to those in the first application example shown in FIG. 5 are denoted by the same reference signs and description thereof will be omitted.

As shown in FIG. 8, the second application example is different from the first application example in that a q-axis voltage command value Vqr and a d-axis voltage command value Vdr output from the controller 14 of the control device 10B are directly input to the control target 20 as the control input value Su.

An angular velocity command value ωr, an angular velocity measurement value ω, a q-axis current measurement value Iq, and a d-axis current measurement value Id are input to the controller 14 of the control device 10B. The angular velocity command value or is input from a higher-order control device to the control device 10B. The controller 14 includes a q-axis speed controller 14a, a d-axis speed controller 14b, a q-axis current controller 14c, and a d-axis current controller 14d.

The angular velocity command value ωr, the angular velocity measurement value ω, and the q-axis current measurement value Iq are input to the q-axis speed controller 14a. The q-axis speed controller 14a performs RL control based on the angular velocity command value ωr, the angular velocity measurement value ω, and the q-axis current measurement value Iq so that a q-axis current command value Iqr is generated. The q-axis speed controller 14a outputs the q-axis current command value Iqr to the q-axis current controller 14c. The d-axis speed controller 14b generates a d-axis current command value Idr having a value of zero and outputs the d-axis current command value Idr to the d-axis current controller 14d.

The q-axis current command value Iqr and the q-axis current measurement value Iq are input to the q-axis current controller 14c. The q-axis current controller 14c performs proportional-integral (PI) control based on the q-axis current command value Iqr, the q-axis current measurement value Iq, and the control parameter P input from the corrector 15 so that a q-axis voltage command value Vqr is generated. The d-axis current command value Idr and the d-axis current measurement value Id are input to the d-axis current controller 14d. The d-axis current controller 14d performs PI control based on the d-axis current command value Idr, the d-axis current measurement value Id, and the control parameter P input from the corrector 15 so that a d-axis voltage command value Vdr is generated. As described above, the controller 14 outputs the q-axis voltage command value Vqr and the d-axis voltage command value Vdr as the control value Su1 (the control input value Su).

The angular velocity command value ωr, the angular velocity measurement value ω, the q-axis current measurement value Iq, the d-axis current measurement value Id, and the prediction value Sy2 are input to the corrector 15 of the control device 10B. The corrector 13 corrects the q-axis voltage command value Vqr and the d-axis voltage command value Vdr based on the angular velocity command value ωr, the angular velocity measurement value ω, the q-axis current measurement value Iq, the d-axis current measurement value Id, and the prediction value Sy2. For example, when the angular velocity measurement value ω is farther from the angular velocity command value or than the angular velocity prediction value ω1, the corrector 15 corrects the q-axis voltage command value Vqr and the d-axis voltage command value Vdr so that the angular velocity measurement value ω is close to the angular velocity command value or. Moreover, when the angular velocity measurement value ω is closer to the angular velocity command value or than the angular velocity prediction value ω1, the corrector 15 corrects the q-axis voltage command value Vqr and the d-axis voltage command value Vdr so that the angular velocity measurement value ω is farther from the angular velocity command value ωr.

More specifically, when the angular velocity measurement value ω is farther from the angular velocity command value or than the angular velocity prediction value ω1, the corrector 15 outputs the first control parameter P1 for increasing change quantities of the q-axis voltage command value Vqr and the d-axis voltage command value Vdr from the first change quantity to the second change quantity as the control parameter P to the controller 14. Moreover, when the angular velocity measurement value ω is closer to the angular velocity command value or than the angular velocity prediction value ω1, the corrector 15 outputs the second control parameter P2 for decreasing change quantities of the q-axis voltage command value Vqr and the d-axis voltage command value Vdr from the first change quantity to the third change quantity as the control parameter P to the controller 14.

When the angular velocity measurement value ω is farther from the angular velocity command value or than the angular velocity prediction value Co due to the operations of the controller 14 and the corrector 15 as described above, the q-axis voltage command value Vqr and d-axis voltage command value Vdr generated so that the change quantity is increased on the basis of the first control parameter P1 are input to the control target 20 as the control input value Su(t) in the t^{th} control cycle. On the other hand, when the angular velocity measurement value ω is closer to the angular velocity command value or than the angular velocity prediction value ω1, the q-axis voltage command value Vqr and the d-axis voltage command value Vdr generated so that the change quantity is decreased on the basis of the second control parameter P2 are input to the control target 20 as the control input value Su(t) in the t^{th} control cycle.

All or some of the functions of the control devices 10A and 10B described above may be implemented by hardware such as an application specific integrated circuit (ASIC), a programmable logic device (PLD), or a field programmable gate array (FPGA) or software such as a program. The program may be recorded on a computer-readable recording medium. The computer-readable recording medium is, for example, a flexible disk, a magneto-optical disk, a ROM, a portable medium such as a CD-ROM, or a storage device such as a hard disk built into a computer system. The program may be transmitted via a telecommunication circuit.

According to at least one embodiment described above, it is possible to provide a control device including a controller configured to generate a control value based on a command value and an output value output from a control target, a predictor configured to predict the output value based on an input value input to the control target and a predictive model of the control target and generate a prediction value indicating a result of predicting the output value, and a corrector configured to correct the control value based on the command value, the output value, and the prediction value so that a calculation amount can be reduced compared with MPC.

The functionality of the elements disclosed herein may be implemented using circuitry or processing circuitry which includes general purpose processors, special purpose processors, integrated circuits, ASICs (“Application Specific Integrated Circuits”), FPGAs (“Field Programmable Gate Arrays”), conventional circuitry and/or combinations thereof which are programmed, using one or more programs stored in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device comprising:
a controller configured to generate a control value based on a command value and an output value output from a control target;
a predictor configured to predict the output value on based on an input value input to the control target and a predictive model of the control target and generate a prediction value indicating a result of predicting the output value; and
a corrector configured to correct the control value based on the command value, the output value, and the prediction value,
wherein the input value input to the control target is the control value corrected by the corrector.

2. The control device according to claim 1, wherein
the corrector corrects the control value so that the output value is close to the command value when the output value is farther from the command value than the prediction value, and
the corrector corrects the control value so that the output value is far from the command value when the output value is closer to the command value than the prediction value.

3. The control device according to claim 2, wherein
the corrector generates a first correction value having the same positive or negative sign as the control value and adds the first correction value to the control value when the output value is farther from the command value than the prediction value, and
the corrector generates a second correction value having a positive or negative sign different from that of the control value and adds the second correction value to the control value when the output value is closer to the command value than the prediction value.

4. The control device according to claim 2, wherein
the controller generates the control value on the basis of the command value, the output value, and a control parameter input from the corrector,
the corrector outputs a first control parameter for increasing a change quantity of the control value from a first change quantity to a second change quantity as the control parameter to the controller when the output value is farther from the command value than the prediction value, and
the corrector outputs a second control parameter for decreasing the change quantity of the control value from the first change quantity to a third change quantity as the control parameter to the controller when the output value is closer to the command value than the prediction value.

5. The control device according to claim 2, wherein
the corrector determines that the output value is farther from the command value than the prediction value when the command value, the output value, and the prediction value satisfy Conditional Inequality (3) of
$$\vert Sy 2 - Sr \vert < \vert Sy 1 - Sr \vert , \qquad ( 3 )$$
where Sr denotes the command value, Sy1 denotes the output value, and Sy2 denotes the prediction value.

6. The control device according to claim 2, wherein
the corrector determines that the output value is closer to the command value than the prediction value when the command value, the output value, and the prediction value satisfy Conditional Inequality (4) of
$$\vert Sy 2 - Sr \vert \geq \vert Sy 1 - Sr \vert , \qquad ( 4 )$$
where Sr denotes the command value, Sy1 denotes the output value, and Sy2 denotes the prediction value.

7. The control device according to claim 1, further comprising an abnormality detector configured to detect an abnormality on based on a deviation between the output value and the prediction value.

8. The control device according to claim 1, wherein
the controller generates the control value by performing proportional-integral-derivative (PID) control based on the command value and the output value, or
the controller generates the control value based on the command value, the output value, and a control model obtained through machine learning.

9. The control device according to claim 1, wherein the corrector corrects a disturbance parameter included in the predictive model based on the command value, the output value, and the prediction value.

10. The control device according to claim 1, wherein the control target includes a motor.

11. A control method comprising:
generating a control value based on a command value and an output value output from a control target;
predicting the output value based on an input value input to the control target and a predictive model of the control target and generating a prediction value indicating a result of predicting the output value; and
correcting the control value based on the command value, the output value, and the prediction value,
wherein the input value input to the control target is the control value corrected on the basis of the command value, the output value, and the prediction value.
